(19) United States
(12) Patent Application Publication
(10) Pub. No.: US 2010/0008562 A1
(43) Pub. Date: Jan. 14, 2010

(54) LATENT IMAGE INTENSITY DISTRIBUTION EVALUATION METHOD, METHOD OF MANUFACTURING THE SEMICONDUCTOR DEVICE AND LATENT IMAGE INTENSITY DISTRIBUTION EVALUATION PROGRAM

(76) Inventors: Masanori TAKAHASHI, Kanagawa (JP); Satoshi TANAKA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/500,039

(22) Filed: Jul. 9, 2009

(30) Foreign Application Priority Data
Jul. 11, 2008 (JP) 2008-181625

(51) Int. Cl. G06K 9/00; G06F 17/50

(52) U.S. Cl. 382/144; 716/21

(57) ABSTRACT

A latent image intensity distribution calculating unit calculates a latent image intensity distribution in the thickness direction of a resist film based on an exposure condition and a mask pattern. An evaluated position calculating unit calculates an evaluated position in the thickness direction of the resist film based on the latent image intensity distribution calculated by the latent image intensity distribution calculating unit. A pattern evaluating unit evaluates a characteristic of a pattern formed on the resist film based on latent image intensity at the evaluated position calculated by the evaluated position calculating unit.

### CROSS-REFERENCE TO RELATED APPLICATIONS

This application is based upon and claims the benefit of priority from the prior Japanese Patent Application No. 2008-181625, filed on Jul. 11, 2008; the entire contents of which are incorporated herein by reference.

### BACKGROUND OF THE INVENTION

1. Field of the Invention

The present invention relates to a latent image intensity distribution evaluation method, a method of manufacturing the semiconductor device, and a latent image intensity distribution evaluation program.

2. Description of the Related Art

Fining of resist patterns used in lithography process has progressed up to the point where line width of the resist patterns reaches order of several-tens of nanometers.

At the same time, in the lithography process, if part of exposure light enters a resist film and reflects on a surface of a base layer that faces the resist film, the incident light interferes with the reflected light in the resist film. As a result, standing waves are generated between the incident light and the reflected light in the resist film, creating an exposure light intensity distribution (a latent image intensity distribution) in which the light intensity changes in an undulating manner in a thickness direction of the resist film.

Such an exposure light intensity distribution is not significant as to be attributed to resist pattern collapse and the like if the line width of the resist pattern is large, e.g., in order of microns, and the resist film is thick. However, if the resist pattern is fine, e.g., in order of several-tens of nanometers, and the film is thin, such an intensity distribution comes to influence a form of the resist pattern greatly, thus preventing the resist pattern to be formed as desired.

Japanese Patent Application Laid-open No. 2006-154245, for example, discloses a method for determining quality of exposure data. To inspect a pattern having an off-specification area in a height direction, this method calculates: characteristics of an image of the exposure pattern, corresponding to the exposure data, on a resist film applied onto a substrate; and the thickness of the resist film after development based on the characteristics of the image of the exposure pattern.

Japanese Patent Application Laid-open No. 2007-324479 discloses a method for obtaining an accurate simulation model. This method at first obtains a characterizing quantity of an optical image based on the intensity distribution of light, and uses a first correlation between information about a form of a photoresist pattern and the characterizing quantity of the optical image and a second correlation between the information about the form of the photoresist pattern and an experimental threshold, to obtain a third correlation between the characterizing quantity of the optical image and the experimental threshold.

However, in these methods disclosed in the Japanese Patent Application Laid-open No. 2006-154245 and 2007-324479, it has been difficult to evaluate the stability of a form of a resist pattern on the substrate or a margin that is attributable to the form thereof based on the optical image, because the form of the resist pattern is evaluated based on the intensity distribution of light on a two dimensional surface of the substrate.

### BRIEF SUMMARY OF THE INVENTION

A latent image intensity distribution evaluation method according to an embodiment of the present invention comprises: obtaining an evaluated position including a position in a thickness direction of a resist film, where a change of latent image intensity becomes greater than a predetermined threshold when an exposure condition is changed, based on a latent image intensity distribution in the resist film, the distribution being calculated by performing lithography simulation based on the exposure condition and a mask pattern; and evaluating latent image intensity at the obtained evaluated position.

A method of manufacturing the semiconductor device according to an embodiment of the present invention comprises: obtaining an evaluated position including a position in a thickness direction of a resist film, where a change of latent image intensity becomes greater than a predetermined threshold when an exposure condition is changed, based on a latent image intensity distribution in the resist film, the distribution being calculated by performing lithography simulation based on the exposure condition and a mask pattern; and evaluating latent image intensity at the obtained evaluated position; repeating adjustment of the mask pattern and evaluation of the latent image intensity until the latent image intensity satisfy the predetermined condition; and transferring the mask pattern on a semiconductor substrate by using a mask formed based on the mask pattern which the latent image intensity satisfy the predetermined condition.

A latent image intensity distribution evaluation program according to an embodiment of the present invention comprises: obtaining an evaluated position including a position in a thickness direction of a resist film, where a change of latent image intensity becomes greater than a predetermined threshold when an exposure condition is changed, based on a latent image intensity distribution in the resist film, the distribution being calculated by performing lithography simulation based on the exposure condition and a mask pattern; and evaluating latent image intensity at the obtained evaluated position.

### BRIEF DESCRIPTION OF THE DRAWINGS

FIG. 1 is a block diagram of a general structure of a lithography simulator according to an embodiment of the present invention;

FIG. 2 is a sectional view of an example of a resist pattern evaluated by lithography simulation according to the embodiment;

FIG. 3 is a flowchart of the lithography simulation method according to the embodiment;

FIG. 4 is a schematic of simulation results according to the embodiment depicting relationships between thickness of a base layer, diffusion length, and latent image intensity distributions in the thickness direction of a resist film;

FIG. 5 is a schematic of simulation results according to the embodiment depicting relationships between a reflection ratio of the base layer, diffusion length, and latent image intensity distributions in the thickness direction of the resist film;

FIG. 6 is a schematic of a simulation result according to the embodiment depicting relationships between an evaluation value A, a position of focus, and thickness of the base layer; and

FIG. 7 is a schematic of exemplary waveforms depicting a method for calculating the evaluation value A in FIG. 6.

### DETAILED DESCRIPTION OF THE INVENTION

A latent image intensity distribution evaluation apparatus, a latent image intensity distribution evaluation method, and a latent image intensity distribution evaluation program according to an embodiment of the present invention will now be explained in detail with reference to the attached drawings. It should be noted that the embodiment described herein is not intended to limit the scope of the present invention.

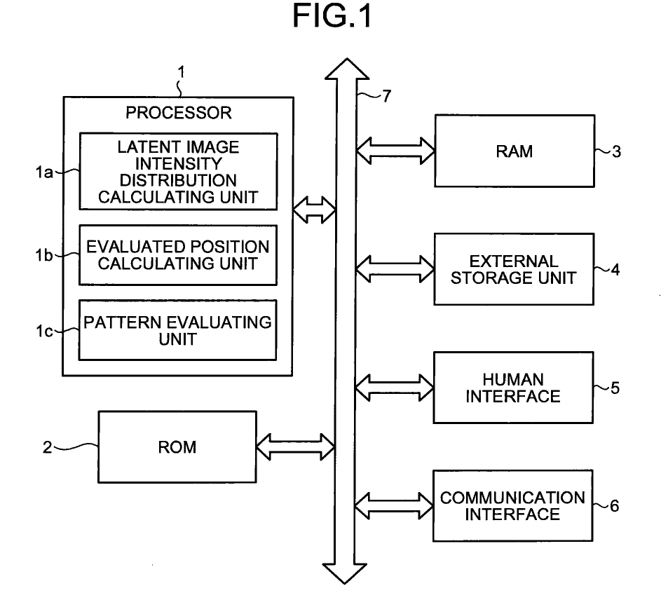

FIG. 1 is a block diagram of a general structure of a latent image intensity distribution evaluation system according to an embodiment of the present invention.

As shown in FIG. 1, the evaluation system may include a processor 1, a read-only memory (ROM) 2, a random access memory (RAM) 3, an external storage unit 4, a human interface 5, and a communication interface 6. The processor 1 includes a central processing unit (CPU) and the like. The ROM 2 stores therein static data. The RAM 3 provides a work area and the like for the processor 1. The external storage unit 4 stores therein a computer program for operating the processor 1 and various data. The human interface 5 intermediates a human user and a computer. The communication interface 6 provides a communication pathway to an external apparatus. The processor 1, the ROM 2, the RAM 3, the external storage unit 4, the human interface 5, and the communication interface 6 are connected via a bus 7.

The processor 1 further includes a latent image intensity calculating unit 1a (lithography simulator), an evaluated position calculating unit 1b, and a pattern evaluating unit 1c. The latent image intensity calculating unit 1a calculates a latent image intensity distribution in a thickness direction of a resist film based on an exposure condition and a mask pattern. The evaluated position calculating unit 1b calculates a position, in the thickness direction of the resist film, where evaluation is performed based on the latent image intensity distribution calculated by the latent image intensity calculating unit 1a. The pattern evaluating unit 1c evaluates the latent image intensity at the evaluated position calculated by the evaluated position calculating unit 1b, and, based on the evaluation result, further evaluates characteristics of a pattern formed on the resist film. At this time, the evaluated position in the resist film, in the thickness direction thereof, may include a position in the thickness direction of the resist film where a change of the latent image intensity becomes the greater than a predetermined threshold when the exposure condition is changed. In other words, the evaluated position may be a position constricting in the thickness direction of the resist film, in the latent image intensity distribution having the latent image intensity equal to or lower than a predetermined value. The pattern characteristics evaluated by the pattern evaluating unit 1c include, for example, stability of a resist form or a process margin attributable to the resist form.

The latent image intensity calculating unit 1a, the evaluated position calculating unit 1b, and the pattern evaluating unit 1c may function on the processor 1 by causing the processor 1 to execute a computer program for evaluating a latent image intensity distribution. The latent image intensity distribution, calculated by the latent image intensity calculating unit 1a, may be calculated by a computer program other than the computer program for evaluating a latent image intensity distribution.

The computer program executed by the processor 1 may be stored in the external storage unit 4 and read onto the RAM 3 upon execution thereof, stored in the ROM 2 in advance, or obtained via the communication interface 6.

The external storage unit 4 may be a magnetic disk such as a hard disk, an optical disk such as a digital versatile disk (DVD), or a portable semiconductor storage device such as a universal serial bus (USB) memory or a memory card. The human interface 5 may include an input interface such as a keyboard or a mouse, and an output interface such as a display or a printer. The communication interface 6 may be a local area network (LAN) card, a modem, or a router for establishing a connection to the Internet or a LAN.

The latent image intensity calculating unit 1a, the evaluated position calculating unit 1b, and the pattern evaluating unit 1c may be implemented as a stand-alone computer, or may be structured with computers connected over a network so that distributive processes are performed thereby.

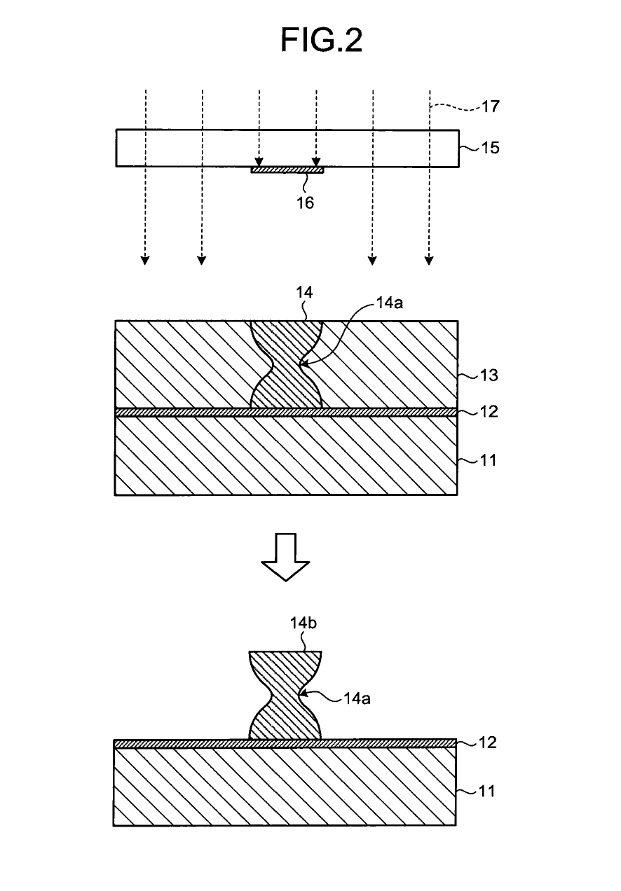

FIG. 2 is a sectional view of an example of a resist pattern evaluated by the latent image intensity evaluation method according to the embodiment.

In FIG. 2, a resist film 13 is formed on a substrate 11, and a base layer 12 is interposed therebetween. The substrate 11 may be a semiconductor substrate on which a semiconductor device is formed, or a glass substrate on which a liquid crystal panel is formed. The base layer 12 may be used as a film for preventing reflection, and be made of a spin-on-glass (SOG) film. A light shielding film 16 using a Cr film or a halftone film is formed over a mask 15. A mask pattern can be formed with the light shielding film 16.

Upon forming a pattern on the resist film 13, the resist film 13 is irradiated with exposure light 17 through the mask 15. When a positive resist is used, the resist at the area irradiated with the exposure light 17 dissolves, and a latent image 14 emerges on the area irradiated with an exposure light 17. At this time, when the exposure light 17 enters the resist film 13, part of the exposure light 17 that entered the resist film 13 reflects on the surface between the resist film 13 and the base layer 12. If the resist pattern is fine, for example in the order of several-tens of nanometers, and the resist film is thin, standing waves are generated. The standing waves create an exposure light intensity distribution that changes in an undulating manner in a thickness direction of the resist film. As a result, especially when the mask pattern is linear, a constriction 13a is formed in the latent image 14 depending on an exposure condition. Such an exposure condition includes a shape of an illumination emitting the exposure light 17, the intensity and time of the exposure, wavelengths of the exposure light 17, a position of focus, and a type and a thickness of the base layer 12.

Then, the resist film 13 formed with the latent image 14 is developed to obtain a resist pattern 13b on the substrate 11. However, while the resist film 13 formed with the latent image 14 is developed, the resist pattern 13b may deform or disappear depending on a level of the constriction 13a, thus not being able to obtain a desired pattern.

Therefore, the lithography simulator shown in FIG. 1 simulates the latent image intensity distribution in the resist film 13 based on an exposure condition and a mask pattern, specifies a position where the constriction 13a occurs based on the latent image intensity distribution, and evaluates the latent image intensity at the constriction 13a to determine whether the desired pattern can be formed.

Then, adjustment of the mask pattern data of the mask 15 and evaluation of the latent image intensity is repeated until the latent image intensity satisfy the predetermined condition.

Then, a mask pattern is transferring to the resist film on a semiconductor substrate by using a mask formed based on the mask pattern which the latent image intensity satisfy the predetermined condition.

Then, etching process or ion implantation and so on is executed by using the resist film transferred the mask pattern, thereby a semiconductor device is manufactured.

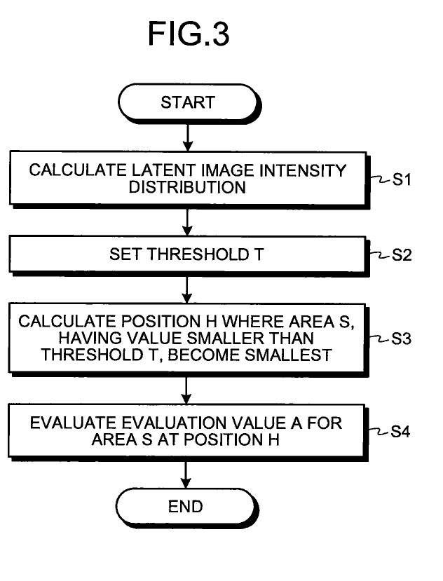

FIG. 3 is a flowchart of the latent image intensity distribution evaluation method according to the embodiment.

In FIG. 3, the latent image intensity calculating unit 1a shown in FIG. 1 calculates a latent image intensity distribution, by way of simulation, in the resist film 13 shown in FIG. 2 based on an exposure condition and a mask pattern (Step S1). Upon simulating the latent image intensity distribution in the resist film 13, a physical model, based on processing conditions used for formation of the resist pattern, may be used; or a latent image intensity distribution, modulated by a statistic model based on processing conditions, may be also used. Examples of such processing conditions include exposure, baking, or development conditions. The latent image intensity distribution, modulated by the statistic model based on the processing conditions, includes the latent image intensity distribution shifting a diffusion length in a resist dissolving material.

Then, the evaluated position calculating unit 1b determines a position where the latent image intensity is evaluated in the resist film 13. In other words, the evaluated position calculating unit 1b determines the position in the thickness direction of the resist film 13 where a change of the latent image intensity becomes greater than a predetermined threshold t when the exposure condition is changed, based on the latent image intensity distribution calculated by the latent image intensity calculating unit 1a as the position where the latent image intensity is evaluated. Specifically, the evaluated position calculating unit 1b calculates a plurality of latent image intensity distributions for a predetermined mask pattern based on the exposure conditions. Then, the evaluated position calculating unit 1b determines, in a surface direction of the resist film, an edge of the mask pattern, or an edge of a design pattern formed by transferring the mask pattern on the resist film. Further, the evaluated position calculating unit 1b can obtain a position where a difference between the latent image intensity distributions becomes greater than a predetermined threshold in the thickness direction of the resist film 13 across the edge, to obtain the evaluated position.

As described in this embodiment, the evaluated position calculating unit 1b may determine, as the evaluated position where a change of the latent image intensity becomes the greatest when the exposure condition is changed, an evaluated position H, which is a constricted position where a size of an area S becomes the smallest in the film surface direction. An area S herein is where the latent image intensity becomes smaller than a threshold T. The threshold T is set so that the area S becomes a desired size or form in the film surface direction (Step S2). The area S is where the latent image intensity becomes smaller than the threshold T in the latent image intensity distribution at a predetermined position in the thickness direction of the resist film 13, or in the latent image intensity distribution averaged for a predetermined range in the thickness direction of the resist film 13. The threshold T may be determined by the evaluated position calculating unit 1b, or provided externally. In this embodiment, the evaluated position calculating unit 1b obtains the evaluated position H where the size of the area S, where the latent image intensity becomes smaller than the threshold T, is the smallest in the film surface direction (Step S3).

The pattern evaluating unit 1c then evaluates, for the latent image intensity distribution at the evaluated position H obtained by the evaluated position calculating unit 1b, whether an evaluation value A in the area S having latent image intensity smaller than the threshold T is within a tolerance. Thus, whether the desired pattern can be formed is determined (Step S4). The evaluation value A in the area S, having a latent image intensity smaller than the threshold T, may be a latent image intensity value at a predetermined position in the evaluated position H, an integration of latent image intensity values smaller than the threshold T in the evaluated position H, or an average of latent image intensity in each unit area of the area S.

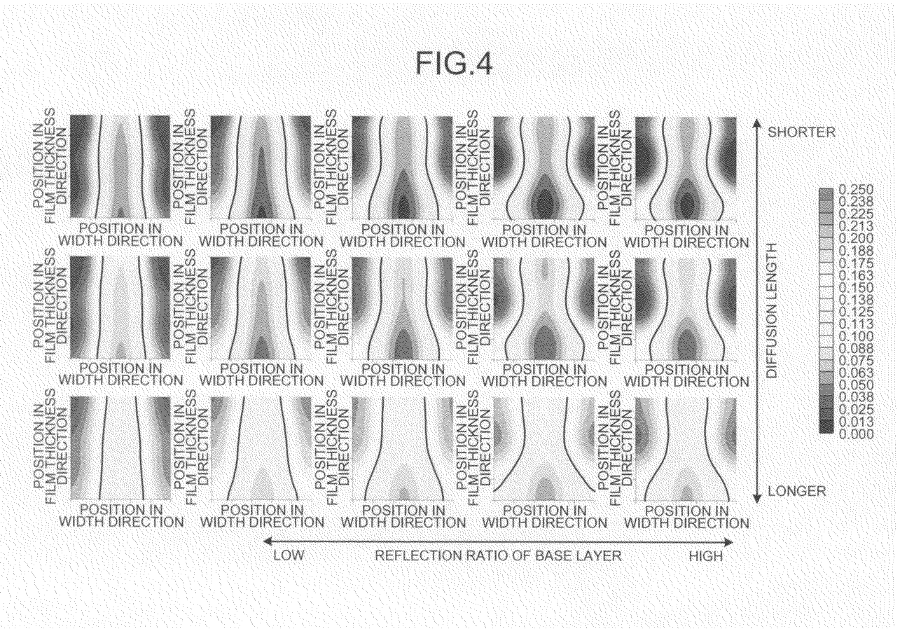

FIG. 4 is a schematic of simulation results according to the embodiment depicting relationships between the thickness of a base layer, diffusion length, and latent image intensity distributions in the thickness direction of a resist film. FIG. 4 depicts distributions of latent image intensity in the thickness direction of the resist film 13 of the mask pattern shown in FIG. 2. In FIG. 4, the vertical axis of each latent image intensity distribution corresponds to the position in the thickness direction of the resist film 13, and the horizontal axis corresponds to the position in a width direction (the film surface direction) of the resist film 13. In FIG. 4, latent image intensity distributions shifting reflection ratios of the base layer 12 shown in FIG. 2 are arranged in the horizontal direction, and those shifting the diffusion length in the resist dissolving material are arranged in the vertical direction.

As shown in FIG. 4, when the reflection ratio of the base layer 12 is low, the mask pattern shown in FIG. 2 can be exactly reproduced as the latent image 14 in the resist film 13. However, when the reflection ratio of the base layer 12 becomes high, standing waves are generated by the incident light and the reflected light in the resist film 13, and the constriction 13a becomes greater. When the diffusion length in the resist dissolving material becomes greater, the boundaries in the latent image intensity distributions become unclear.

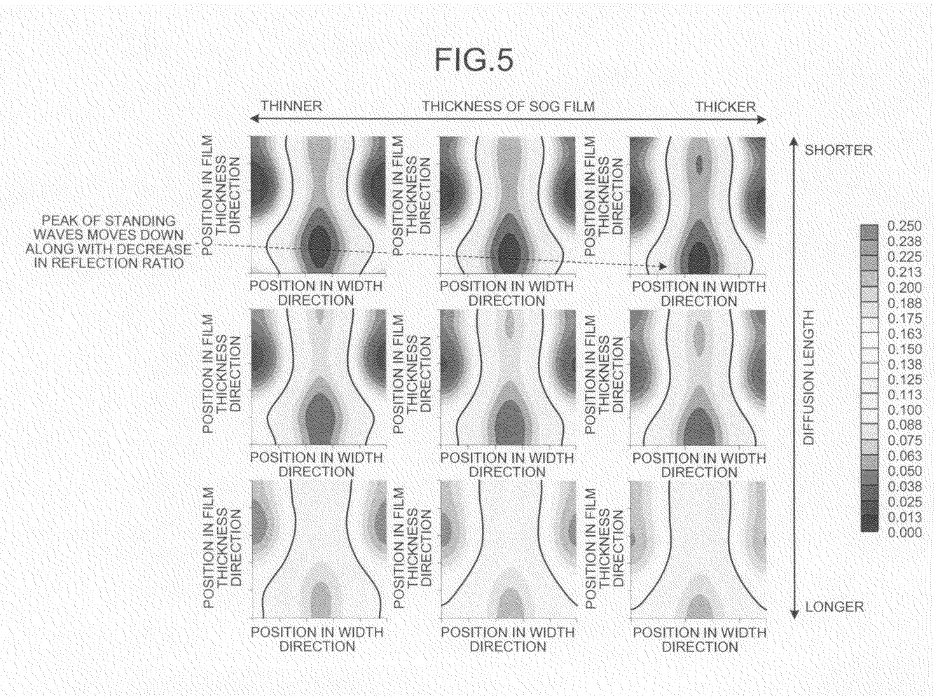

FIG. 5 is a schematic of simulation results according to the embodiment depicting relationships between a reflection ratio of the base layer, diffusion length, and latent image intensity distributions in the thickness direction of the resist film. FIG. 5 depicts the latent image intensity distributions in the thickness direction of the resist film 13 of the mask pattern shown in FIG. 2. In FIG. 5, the vertical axis of each latent image intensity distributions corresponds to the position in the thickness direction of the base layer 12, and the horizontal axis corresponds to the position in the width direction (the film surface direction) of the resist film 13. In FIG. 5, the latent image intensity distributions shifting the thickness of the base layer 12 shown in FIG. 2 are arranged in the horizontal direction, and those shifting the diffusion length in the resist dissolving material are arranged in the vertical direction. In this example, an SOG film is used for the base layer 12.

As shown in FIG. 5, when the thickness of the SOG film is changed, a peak of the standing waves shifts in the thickness direction of the resist film 13, and the position of the constriction 13a shifts in the thickness direction of the resist film 13. When the diffusion length in the resist dissolving material becomes greater, the boundaries in the latent image intensity distributions become unclear.

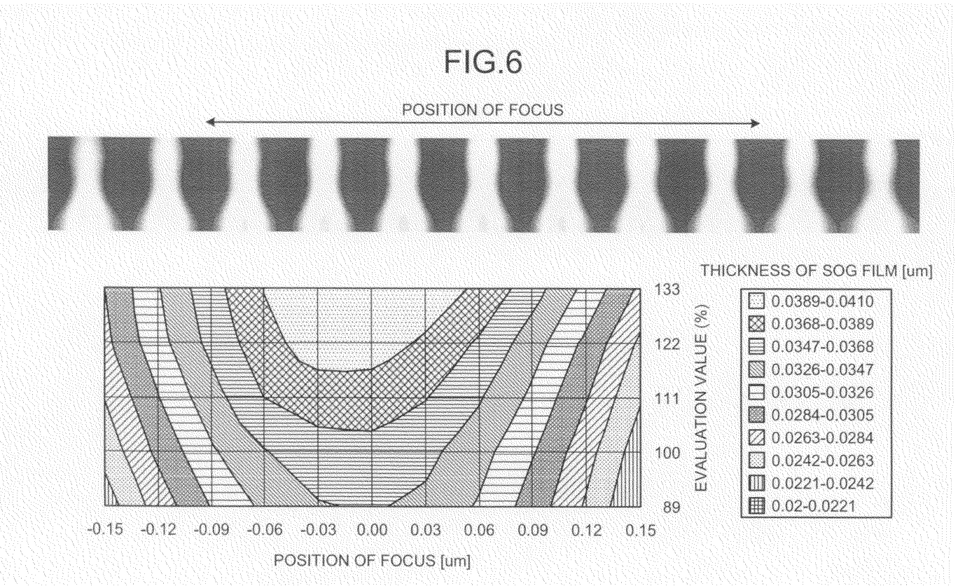

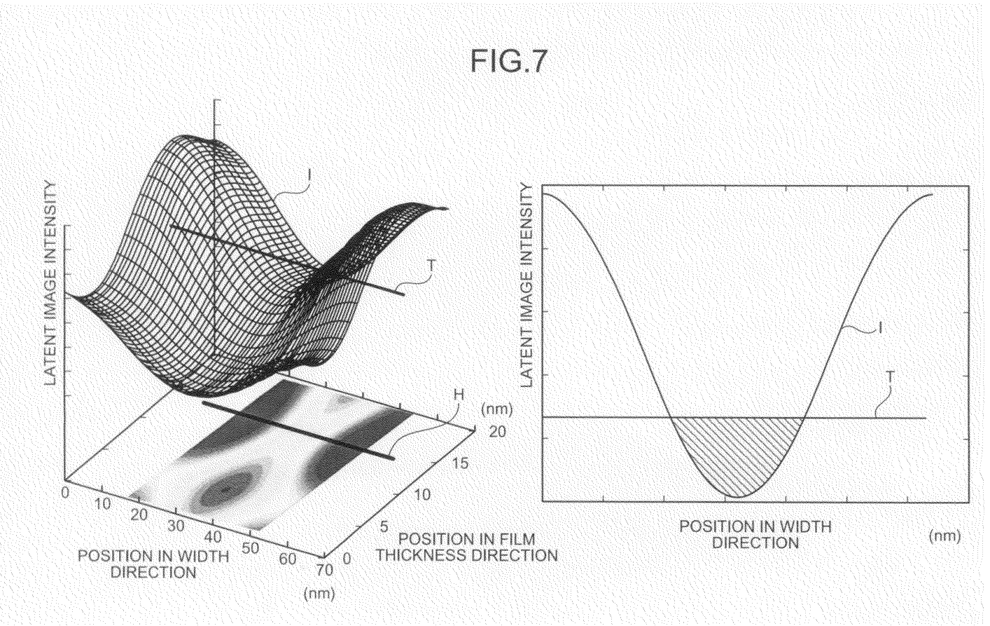

FIG. 6 is a schematic of a simulation result according to the embodiment depicting relationships between an evaluation value A, a position of focus, and thickness of the base layer. FIG. 7 is a schematic of exemplary waveforms depicting a method for calculating the evaluation value A in FIG. 6. In this example, an SOG film is used for the base layer.

FIG. 6 indicates that the greater the thickness of the SOG film is, the greater the evaluation value A becomes. Therefore, stability of the resist form can be improved by increasing the thickness of the SOG film. In this manner, a resist pattern can be formed more easily. As shown in FIG. 7, in this example, as the evaluation value A, an integration of the latent image intensity I in the area S (shown as hatched in FIG. 7), having the latent image intensity lower than the threshold T, is evaluated as a ratio in relation to the threshold T.

In this example, the reflection ratio of the exposure light 17 on the surface of the SOG film (the base layer 12) that faces the resist film 13 is approximately 2% under the standard condition before conducting the evaluation. An influence of the standing waves can be adjusted by increasing the thickness of the SOG film, in comparison to that in the standard condition, within a range where the reflection ratio almost does not change. In this manner, the resist pattern can be formed more easily.

In addition, the evaluation value A can be increased by slightly adjusting the position of focus, shown in FIG. 6, in the thickness direction. Also in this manner, the resist pattern can be formed more easily.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A latent image intensity distribution evaluation method comprising:
obtaining an evaluated position including a position in a thickness direction of a resist film, where a change of latent image intensity becomes greater than a predetermined threshold when an exposure condition is changed, based on a latent image intensity distribution in the resist film, the distribution being calculated by performing lithography simulation based on the exposure condition and a mask pattern; and
evaluating latent image intensity at the obtained evaluated position.

2. The latent image intensity distribution evaluation method according to claim 1, wherein
the obtaining of the position in the thickness direction of the resist film where the change of the latent image intensity becomes greater than a predetermined threshold when the exposure condition is changed comprises:
calculating a plurality of latent image intensity distributions for a predetermined mask pattern based on a plurality of exposure conditions;
determining, in a surface direction of the resist film, an edge of the predetermined mask pattern, or an edge of a design pattern formed by transferring the mask pattern on the resist film; and
obtaining a position where a difference between the latent image intensity distributions becomes greater than a predetermined threshold in the thickness direction of the resist film across the edge.

3. The latent image intensity distribution evaluation method according to claim 1, wherein
the evaluated position includes a position where a form of an area, having latent image intensity smaller than predetermined latent image intensity, in the latent image intensity distribution, is constricted in the thickness direction of the resist film.

4. The latent image intensity distribution evaluation method according to claim 3, wherein
the predetermined latent image intensity is set so that the size or form in the surface direction of the resist film of the area having the latent image intensity smaller than the predetermined latent image intensity, in a latent image intensity distribution obtained by averaging the calculated latent image intensity distribution in the resist film in the thickness direction thereof, becomes a desired size or form.

5. The latent image intensity distribution evaluation method according to claim 1, wherein a spin-on-glass (SOG) film is used as a base layer of the resist film.

6. The latent image intensity distribution evaluation method according to claim 5, wherein thickness of the base layer is shifted upon obtaining the evaluated position.

7. The latent image intensity distribution evaluation method according to claim 5, wherein diffusion length in a resist dissolving material is shifted upon obtaining the evaluated position.

8. The latent image intensity distribution evaluation method according to claim 5, wherein a position of focus is shifted upon obtaining the evaluated position.

9. A method of manufacturing the semiconductor device comprising:
obtaining an evaluated position including a position in a thickness direction of a resist film, where a change of latent image intensity becomes greater than a predetermined threshold when an exposure condition is changed, based on a latent image intensity distribution in the resist film, the distribution being calculated by performing lithography simulation based on the exposure condition and a mask pattern; and
evaluating latent image intensity at the obtained evaluated position;
repeating adjustment of the mask pattern and evaluation of the latent image intensity until the latent image intensity satisfy the predetermined condition; and
transferring the mask pattern on a semiconductor substrate by using a mask formed based on the mask pattern which the latent image intensity satisfy the predetermined condition.

10. The method of manufacturing the semiconductor device according to claim 9, wherein
the obtaining of the position in the thickness direction of the resist film where the change of the latent image intensity becomes greater than a predetermined threshold when the exposure condition is changed comprises:
calculating a plurality of latent image intensity distributions for a predetermined mask pattern based on a plurality of exposure conditions;
determining, in a surface direction of the resist film, an edge of the predetermined mask pattern, or an edge of a design pattern formed by transferring the mask pattern on the resist film; and
obtaining a position where a difference between the latent image intensity distributions becomes greater than a predetermined threshold in the thickness direction of the resist film across the edge.

11. The method of manufacturing the semiconductor device according to claim 9, wherein
the evaluated position includes a position where a form of an area, having latent image intensity smaller than predetermined latent image intensity, in the latent image intensity distribution, is constricted in the thickness direction of the resist film.

12. The method of manufacturing the semiconductor device according to claim 9, wherein
the predetermined latent image intensity is set so that the size or form in the surface direction of the resist film of the area having the latent image intensity smaller than the predetermined latent image intensity, in a latent image intensity distribution obtained by averaging the calculated latent image intensity distribution in the resist film in the thickness direction thereof, becomes a desired size or form.

13. The method of manufacturing the semiconductor device according to claim 9, wherein a spin-on-glass (SOG) film is used as a base layer of the resist film.

14. The method of manufacturing the semiconductor device according to claim 9, wherein thickness of the base layer is shifted upon obtaining the evaluated position.

15. The method of manufacturing the semiconductor device according to claim 9, wherein diffusion length in a resist dissolving material is shifted upon obtaining the evaluated position.

16. The method of manufacturing the semiconductor device according to claim 9, wherein a position of focus is shifted upon obtaining the evaluated position.

17. A latent image intensity distribution evaluation program causing a computer to execute:
obtaining an evaluated position including a position in a thickness direction of a resist film, where a change of latent image intensity becomes greater than a predetermined threshold when an exposure condition is changed, based on a latent image intensity distribution in the resist film, the distribution being calculated by performing lithography simulation based on the exposure condition and a mask pattern; and
evaluating latent image intensity at the obtained evaluated position.

18. The latent image intensity distribution evaluation program according to claim 17, wherein
the obtaining of the position in the thickness direction of the resist film where the change of the latent image intensity becomes greater than a predetermined threshold when the exposure condition is changed comprises:
calculating a plurality of latent image intensity distributions for a predetermined mask pattern based on a plurality of exposure conditions;
determining, in a surface direction of the resist film, an edge of the predetermined mask pattern, or an edge of a design pattern formed by transferring the mask pattern on the resist film; and
obtaining a position where a difference between the latent image intensity distributions becomes greater than a predetermined threshold in the thickness direction of the resist film across the edge.

19. The latent image intensity distribution evaluation program according to claim 17, wherein
the evaluated position includes a position where a form of an area, having latent image intensity smaller than predetermined latent image intensity, in the latent image intensity distribution, is constricted in the thickness direction of the resist film.

20. The latent image intensity distribution evaluation program according to claim 17, wherein
the predetermined latent image intensity is set so that the size or form in the surface direction of the resist film of the area having the latent image intensity smaller than the predetermined latent image intensity, in a latent image intensity distribution obtained by averaging the calculated latent image intensity distribution in the resist film in the thickness direction thereof, becomes a desired size or form.
